(19) United States
(12) Patent Application Publication
(10) Pub. No.: US 2010/0242853 A1
(43) Pub. Date: Sep. 30, 2010

(54) REPTILE FARMING SYSTEM

(75) Inventor: Grahame Webb, Sanderson (AU)

Correspondence Address: CALFEE HALTER & GRISWOLD, LLP, 800 SUPERIOR AVENUE, SUITE 1400, CLEVELAND, OH, 44114, US

(73) Assignee: WILDLIFE MANAGEMENT INTERNATIONAL PTY. LIMITED, Sanderson, Northern Territory (AU)

(21) Appl. No.: 12/301,780

(22) PCT Filed: May 24, 2007
(86) PCT No.: PCT/AU2007/000709

§ 371 Date: Sep. 22, 2009

(30) Foreign Application Priority Data
May 24, 2006 (AU) 2006902788

(51) Int. Cl. A01K 1/10

(52) U.S. Cl. 119/456; 119/515

(57) ABSTRACT

A reptile grow-out pen assembly (20) for containing a reptile, in particular a crocodile, includes an elongate container having at least one side having an opening (42) for entry of food into the container and at leat one closable and openable aperture (40f) associated with the container for entry and exit of the reptile, the container having at least a floor portion (40d) and side wall portion wherein in use of the reptile grow-out pen, at least a portion of the floor and at least a portion of the side wall are adapted to be submerged in water. Also disclosed is a reptile grow-out arrangement used for growing-out of reptiles including a plurality of enclosures (10a, 10b, 10c) each having at least one water body and a sloped reptile basking region located within the reptile enclosure and wherein the enclosures are connected so as to allow the flow of water from one enclosure to another; wherein the proportions of the enclosure are predetermined to minimise infighting amongst the reptiles therein.

### FIELD OF INVENTION

This invention relates to the housing of amphibious creatures in captive situations and in particular the housing and movement of crocodiles, alligators and caimans during their grow-out phase.

### BACKGROUND OF THE INVENTION

The crocodile farming industry is relatively young, with pioneering efforts in the 1960's and most development of the industry occurring since 1980. The development of a crocodile farming industry was primarily a result of bans on crocodile hunting. When legal hunting ceased the wild population of crocodiles had been greatly depleted and could not provide a sustainable source of skins and by-products. It is readily acknowledged within the reptile farming industry, that early work in egg incubation, effects of incubation on hatching growth and survival, associated technologies, including diets, temperature, and captive breeding techniques, formed the basic information for much of today's commercial farming of crocodiles in Australia and elsewhere.

A variety of minced meats (kangaroo, wild pig, horse) high in protein and low in fat, supplemented with vitamins and calcium and minced chicken heads can support hatchlings in their first year of life. After that, a steady transition to whole chicken heads is the most common approach to feeding these reptiles.

A hatchling to one-year of age requires continuous attention and grading for size. After one-year, the animals are transferred to larger enclosures, and continue to be graded and separated according to size. An example of an enclosure used in current crocodile farming is depicted in FIG. 1. The crocodile farming industry appears to use two or more enclosures for the post-hatchling grow-out phase, but in all cases the enclosures house multiple crocodiles and the enclosures include a surrounding side wall to prevent egress of the crocodiles and a portion of the enclosures provides for a pool of water and another portion provides a crocodile basking area.

The desired consequence of the grow-out process is for the crocodiles to reach a length of at least 140 centimetres, which is achieved within 18 to 36 months after the crocodile is hatched. This minimum length is most suitable because the underbelly skin product is then the minimum size for handbags which is the primary end market product for crocodile skins.

However, infighting amongst these animals within the grow-out enclosures can result in damage in the form of one or more blemishes and scars to the underbelly skin of the crocodile; consequently, the value of the skin can be reduced by 25 to 80%, or be rendered worthless.

Current crocodile farming grow-out enclosures are constructed to minimize damage to the skin of the animal. For example, the enclosures is built with smooth concrete walls and floors to avoid scratching the animal. Water quality within the enclosures is important so as to reduce infectious agents including bacterial and fungal, and chlorine and other chemicals, fungicides and biocides are added to control these and other elements of water quality.

The infighting control and water management of farmed crocodiles are problems for current crocodile farming arrangements.

### SUMMARY OF THE INVENTION

In a broad aspect of the invention a reptile grow-out pen assembly for containing a reptile in particular, a crocodile includes: an elongate container having at least one side having an opening for entry of food into the container and at least one closable and openable aperture associated with the container for entry and exit of the reptile, the container having at least a floor portion and side wall portion wherein in use of the reptile grow-out pen, at least a portion of the floor and at least a portion of the side wall are adapted to be submerged in water.

In an aspect of the invention at least one region of the floor of the grow-out pen is sloped with respect to another region of the floor, and where in use, at least a portion of the sloped floor region and at least a portion of the side are submerged in water.

In a further aspect of the invention the assembly has a smooth internal floor side and at least two smooth internal sides.

In an aspect of the invention the smooth sides consist of a high density polyethylene sheet associated with a respective wall.

In an aspect, the reptile grow-out pen is constructed of connected portions that can be formed into a substantially flat structure.

In an aspect, the reptile grow-out pen is adapted in an un-constructed state to be stackable.

In another broad aspect of the invention a reptile grow-out pen arrangement used for growing out of reptiles includes: at least one water body; at least two reptile grow-out pen assemblies according to a preceding paragraph wherein each assembly has a portion of the respective floor of the pen and at least a portion of the side portion of the respective pen submerged in the water body.

In a further aspect of the invention water flows through each said at least one water body.

In another aspect of the invention a reptile grow-out arrangement used for growing out of reptiles includes: a plurality of enclosures each having at least one water body and a sloped reptile basking region located within the reptile enclosure and wherein the enclosures are connected so as to allow the flow of water from one enclosure to another; wherein the size of the enclosure is of a predetermined quantity to minimize infighting amongst the reptiles therein.

A detailed description of one or more preferred embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

The reference to any prior art in this specification is not, and should not be taken as, an acknowledgment or any form of suggestion that such prior art forms part of the common general knowledge.

### BRIEF DESCRIPTION OF THE DRAWINGS

FIG. 1 depicts a prior art crocodile enclosure showing the distribution of a number of crocodiles within the same enclosure;

FIG. 2 depicts a grow-out enclosure according to one aspect of the invention;

FIG. 3 depicts a plurality of grow-out enclosures according an aspect of the invention;

FIG. 4 depicts a perspective view of a single grow-out pen according to an aspect of the invention;

FIG. 5 depicts a longitudinal cross-section of the grow-out pen depicted in FIG. 4;

FIG. 6 depicts a stack of partially deconstructed grow-out pens of the type depicted in FIG. 4;

FIG. 7 depicts a stack of constructed grow-out pens of the type depicted in FIG. 4;

FIG. 8 depicts a perspective view of a grow-out pen according to another aspect of the invention; wherein the floor wall has two slopes.

FIG. 9 depicts a partial view of adjacent grow-out pens each occupied by a crocodile;

FIG. 10 depicts a body of water in which a plurality of grow-out pens as per FIG. 9 are located according to the invention;

FIG. 11 depicts a body of water in which a plurality of grow-out pens as per FIG. 8 are located according to the invention, and

FIG. 12 depicts two connected bodies of water in which a plurality of grow-out pens are located.

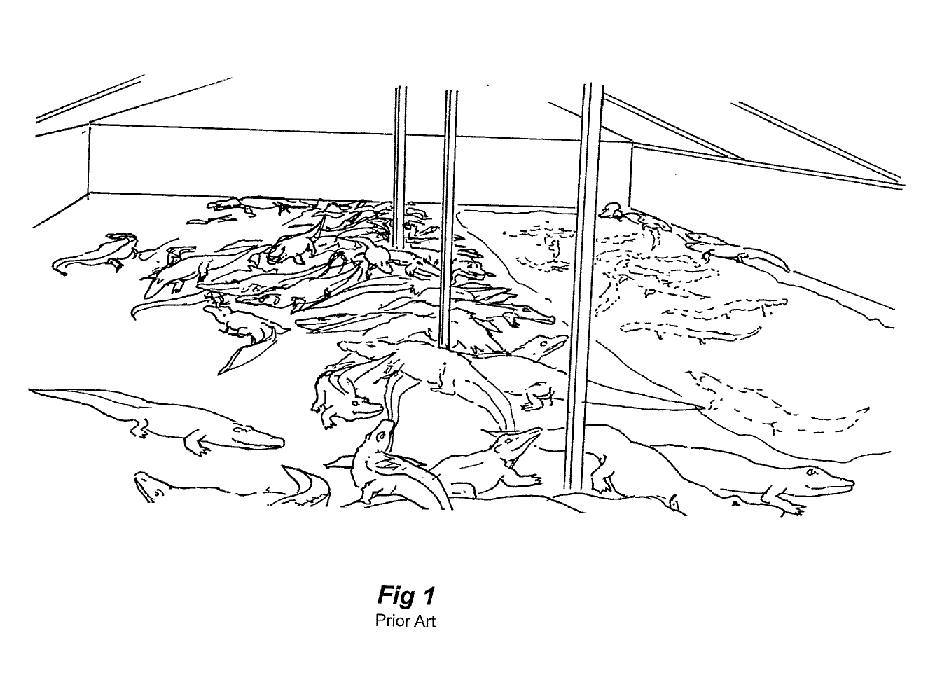

### DETAILED DESCRIPTION OF THE INVENTION

Described herein is a system and apparatus for rearing crocodiles beyond the hatchling stage to a desired grow-out stage. The system and associated apparatus are also suitable for other amphibious creatures including alligators and caimans. The term reptile is used herein for convenience and includes crocodiles, alligators and caimans.

The system of the invention includes the use of a number of staged grow-out enclosures each having a water and land region followed by the use of an caged environment for a final grow-out stage of individual reptiles, details of which are provided below.

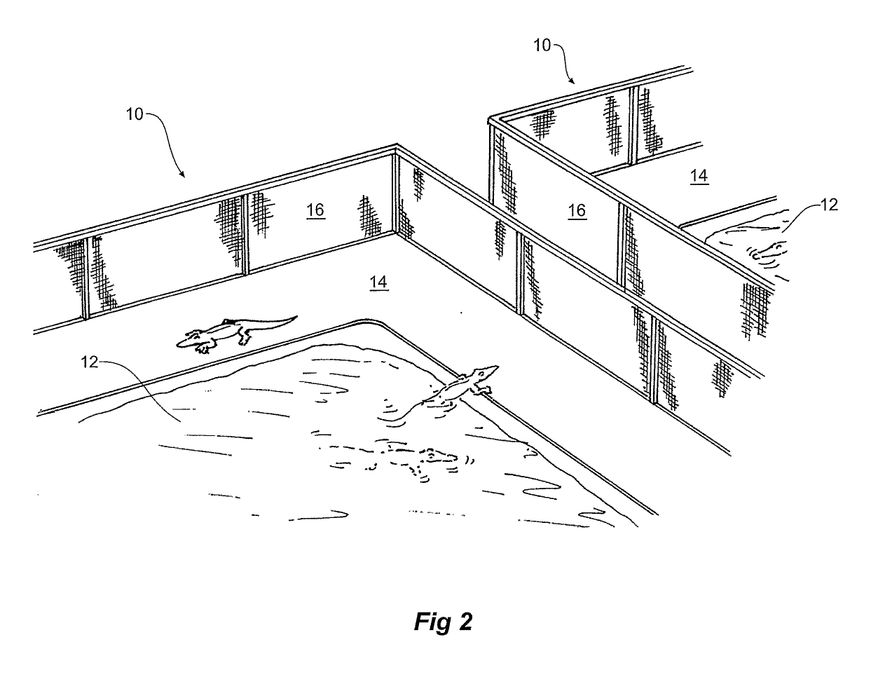

FIG. 2 depicts a grow-out enclosure 10 according to an aspect of the invention. It is built to predetermined proportions to accommodate multiple crocodiles per enclosure (150-350). The proportions not only include the area of the enclosures but the depth of the water body and the area which forms the banks of the enclosure where there is no water. Each enclosure has a region 12 where the maximum water depth is greater than 2 metres at some point in the pond area. Each enclosure has sloping edges 14 on all sides of the water that gradually reach an existing land surface if created out of the land. In the alternative the enclosures could be located deeper in-ground or they could be constructed above ground. Suitably strong and high barriers 16 are located so as to prevent egress of the occupants.

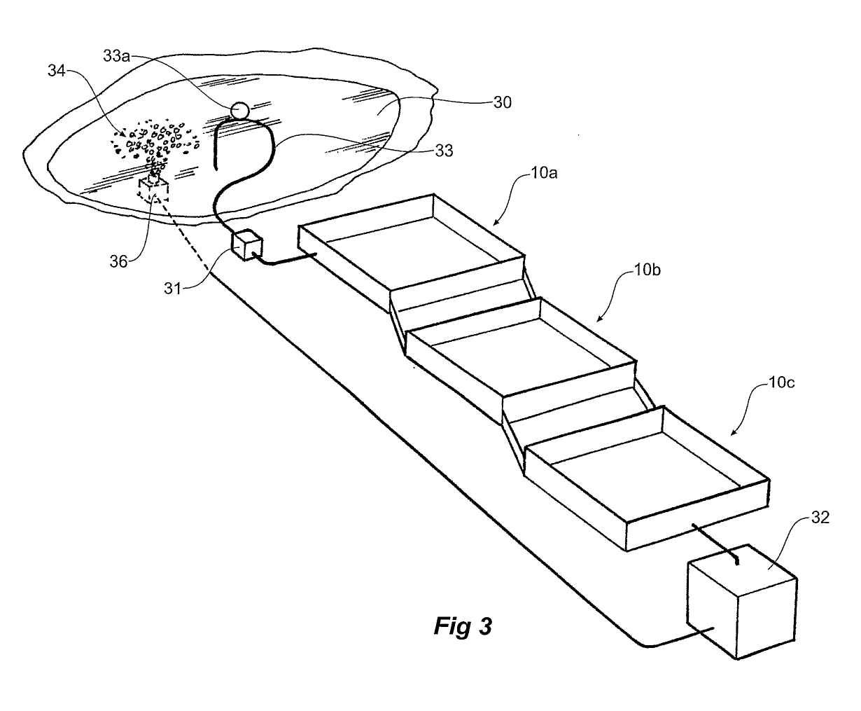

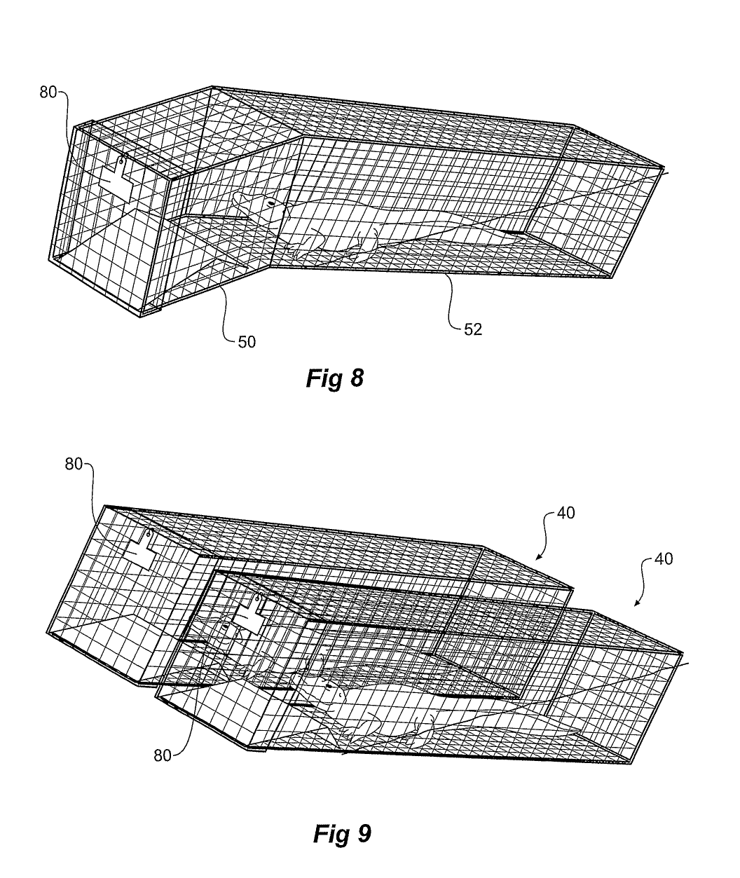

In use there is a preference for there to be 3 growing stages (refer to 10a, 10b and 10c in FIG. 3) hence three reduced occupant density similar sized enclosures as is depicted in FIG. 3 before the use of individual grow-out pens (refer to FIGS. 8 and 9) each being described in greater detail later in the specification. The use of three grow-out stages hence three enclosures in the embodiment does not define the only such arrangement as the number of stages may vary according to the reptile and other factors such as quantity to handled, environment, etc.

Each grow-out enclosure 10a, 10b, and 10c is equipped to circulate water from a reservoir 30. The arrangement depicted in FIG. 3 shows a reservoir 30 located proximate to the enclosures and in an ideal arrangement it is located higher than the required water level in the first and highest enclosure 10a. The succeeding enclosures are successively lower so as to allow gravity feed but in cases where that is not possible pumps (not shown can be employed to carry the water from one enclosure to another. In FIG. 3 a pump 31 is used for drawing water from the reservoir 30 via a float suspended 33a pipe 33.

Exchange of the water between the reservoir and the enclosures will have less cleaning and conditioning requirements if the circulation includes oxygenation at some point it the reticulation system. One approach to achieving that aim, is to provide a common reservoir 30 from which water is carried to the enclosures 10a, 10b, and 10c. The reservoir pumping system includes an oxygenation arrangement 34 that in one example is the pumping of water into the atmosphere and returned to the reservoir 30.

The arrangement depicted in FIG. 3 includes a sump 32 located intermediate the last enclosure 10 c and the reservoir 30. The sump 32 fills to a predetermined level and then the level therein is reduced by pumping via pump 36 into the reservoir.

Progressively larger enclosures can be used to accommodate the growing reptiles or the density of the occupants is reduced accordingly. The enclosures could be sized to provide a larger area per reptile and the combination of size of the enclosure and the density of the population in each enclosure will minimize in-fighting.

Observation of the population of reptiles in a particular enclosure can identify troublesome reptiles. In most instances the troublesome reptiles can be moved into an individual grow-out pen earlier than would typically be the case.

The number of reptiles in any one enclosure is based on the character of the reptile population. The guidelines may vary for different species. Some of the characteristics include their sizes, the size of the enclosure, including the water to land ratio, the depth of water and the interface length between the water and basking area so that as the occupants grow larger they can have a proportionately longer interface between the waters edge and the basking region, the weather including the temperature and humidity of the air, the water supply quality, the temperature of the water (in particular with regards alligators) and quality of food, etc. By way of example the number of reptiles in successive enclosures of similar size (enclosures of total area of 240 m²) is 350, 240, 150 respectively.

FIG. 3 depicts in schematic form a plurality of enclosures 10a, 10b and 10c and a reservoir 30 of water. Water circulation amongst the enclosures can be by way of pumps, gravity and/or a combination of both of these circulation methods. As indicated above the enclosures are similar sizes and depending on the lay of the land in which they are located the enclosure floor levels may or may not be different to each other. In one arrangement depicted in FIG. 3, a cascading array of enclosures allows for gravity to facilitate movement of water from the highest enclosure 10a to the lowest enclosure 10c via enclosure 10b. A reservoir 30 at the top or bottom of the array of enclosures can be used to supply water by way of gravity as required and/or by using pumps 31, 36 and 32. Total replacement of water in an enclosure preferably occurs twice every three days or so but this rate of exchange can vary depending on a number of factors including but not exclusively due to one or more of the following: the atmospheric temperature, the rainfall in the region, water condition, etc.

The reservoir is where water treatment can be most easily achieved, including aeration and filtration. In addition the water can be treated by the addition of one or more anti-infection agents.

The final grow-out stage for a crocodile is done in a grow-out pen (1 reptile per pen).

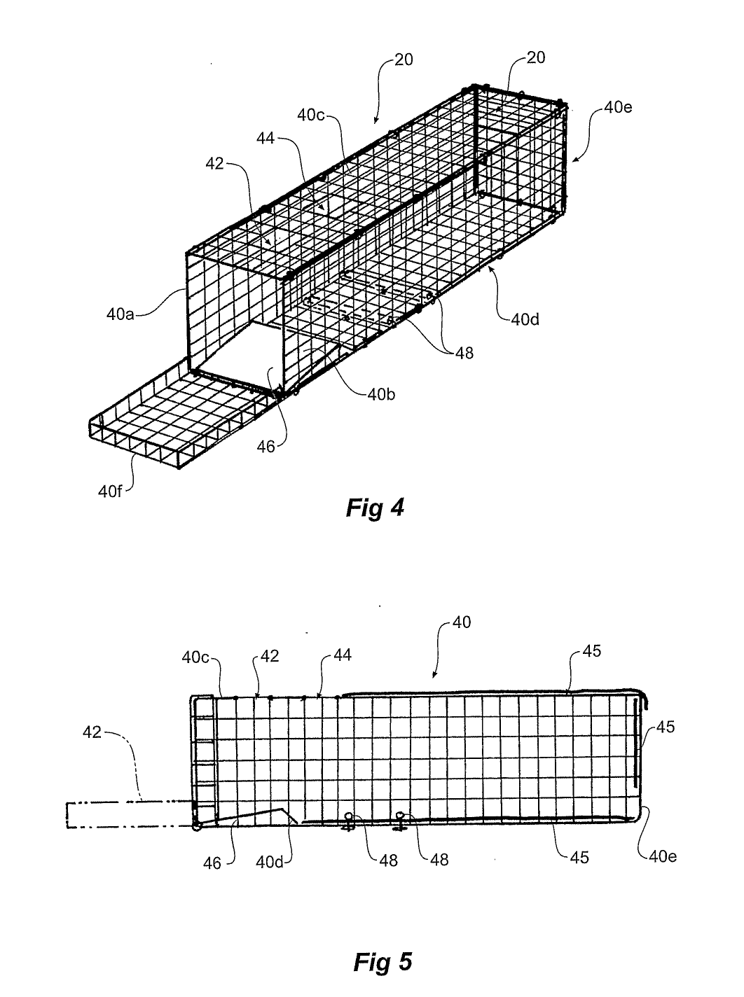

FIGS. 4 and 5 depict a preferred embodiment of a grow-out pen 40. The displayed configuration of the pen is a container, in the embodiment depicted having six sided at least one side wall 40f (door) being arranged to allow insertion and removal of a reptile to the container. The structure of this embodiment is constructed of flat sides each of which strong enough to retain the reptile within the container. The sides may be formed from the same material and may involve bending of the one piece of the material or be constructed of multiple pieces of the same material. Alternatively the construction involves multiple types of material suitable for that portion of the assembly. Different portions of the assembly are required to perform different functions and their shape and material can be chosen to suit.

In one example, the container is constructed of wire mesh which has sufficient strength to withstand the forces involved in containing a reptile but which is also light enough to allow the container to be lifted by one person. In one example the mesh form is approximately 50×75-80 mm rectangular with the wire element of the mesh being of 2-3 mm outer diameter. The mesh being preferably galvanized steel but it can also be of stainless steel, so as to be suitable for at least long term use in water or partial submersion. The container is, in this embodiment, constructed of mesh to allow the flow of water through the enclosure. Whether solid or mesh like there is a need for water to flow through the enclosure while it is partially submerged to allow the occupant to have a water as part of its environment. The lightness of the enclosure is relative to what a person can lift and move allowing for an empty container to be moved by one person and when the pen is occupied the pen and occupant can be weighed with a relatively simple device and thus allow for the tracking of growth of the occupant over time.

The pen, if made of mesh, is preferably provided with a smooth internal surface to minimize abrasion to the skin of the reptile. Not all the internal surfaces of the container need be lined or otherwise constructed of material which does not need a separate lining and in the embodiment depicted, smooth high density polyethylene sheet 45 (shown in cross-section in FIG. 5) is attached to each of the longitudinal vertical side walls 40a and 40b (not shown), a portion of the longitudinal uppermost wall 40c (roof) 24 positioned on the outside only and covered so as to allow the occupant to bask in the sun, the inside of the longitudinal base wall 40d (floor) and the transverse vertical end wall 40e (none of them being depicted in FIG. 4).

The opposed transverse vertical end wall 40f as described earlier is arranged to be opened and closed to act as an insertion and removal closure (door). A small lip about the end wall 40f is formed, in the mesh constructed embodiment of the enclosure, by turning up a row of mesh along the periphery of the end wall so as to ensure closure of the pen, especially when its occupant is a reptile of considerable strength. The end wall 40f is hinged or otherwise connected to the base wall 40b so that it can be readily removed or lie flat over the ground while the reptile enters and exits the pen. To fix the closure in a closed position one or more pieces of wire that can be formed into a clip are used (not shown) to secure the end wall 40f to the surrounding walls and in the case of a hinged wall to the wall 40c (roof) of the pen.

Openings 42 and 44 in the mesh allow insertion/removal of feed (via opening 42) and the entry of a reptile incapacitation device (via opening 44). A portion of the floor of the pen is sectioned off from the remainder of the floor by a structure 46 that is rises above the floor level. This structure keeps the food separate from the remainder of the floor area and minimizes the water affecting the food. The floor level of the structure 46 is arranged, in use, to slope away for the water so that food located thereon can be better isolated from the water.

FIG. 5 discloses internal claw holds to allow the contained reptile to crawl up the floor surface. In this embodiment the floor is smooth and in uses depicted the floor is sloped. In this embodiment, the claw holds are plastic tubes of approximately 25 mm outer diameter 48 fixed laterally across the floor of the pen to allow the reptile to crawl up the smooth and sometimes wet floor surface which becomes sloped when the pen is in use.

The outer shape of the side of the pen is shaped, in the example depicted, so as to allow adjacent positioning in a structured water source as is depicted in FIGS. 9-11 details of which will be described in greater detail later in the specification.

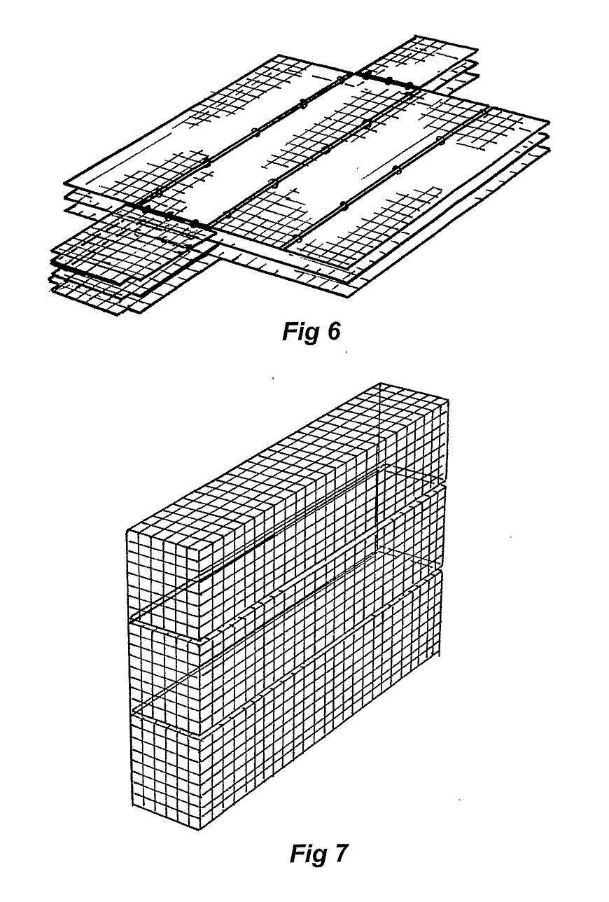

FIG. 6 depicts the un-constructed form of the pen consisting of the six side walls. In one embodiment the mesh is shaped from one sheet of mesh and the sides are formed by bending and joining by suitable means along the seams. In another embodiment the sides are separate from each other and hingedly connected so as to allow them to all lay in the same plane until they need to be positioned in to a pen shape as depicted in the figures. When in this un-constructed form the container is most suitable for shipping and easily stacked. Construction at their destination is simple and does not require any special tools. The destination may in some situations be at very remote locations that may only have unskilled workers available to erect the containers into the form shown as example embodiments in FIGS. 4 and 5. The respective seams of the various side walls can be secured with suitable wire or clips that can be supplied or easily sourced. The shape of the blank for the enclosure of FIG. 8 will be different to that depicted in FIG. 6 to accommodate the need for a different final shape.

FIG. 7 depicts a stacked array of constructed grow-out pens of the type depicted in FIG. 4.

The embodiment of a reptile pen as depicted in FIGS. 4 to 7 is shown to be modular which allows for each side wall to be replaceable or even parts of the side wall to be repaired or replaced.

In one embodiment the proportions of the reptile pen includes dimensions which are approximately 2.2 metres long by 0.5 metres wide and 0.35 metres high.

In use, each reptile pen is tagged 80 (as shown in FIGS. 8 and 9 and the tag carries a unique identification such as a number so as to identify the occupant and facilitate record keeping of growth (length and weight), skin condition (photographic evidence) and other matters with regard to feeding regimes of the occupant, etc.

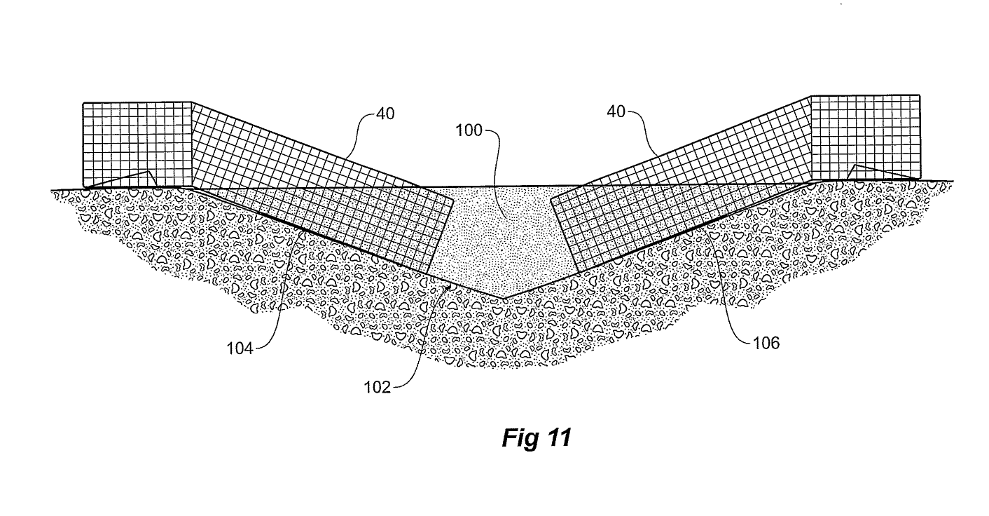

In a further embodiment of the pen as depicted in FIG. 8 there is shown a perspective view of a reptile pen shape having a substantially horizontal floor surface 50 at the nominal head end of the pen and sloped surface 52 at the nominal tail end of the pen. In use the floor surface substantially conforms to the shape of the water channel as shown in FIG. 11.

FIG. 9 depicts a perspective view of adjacent grow-out pens each occupied by a crocodile. The pens 40 depicted in FIG. 8 are of the type having a flat floor surface.

In an arrangement for the positioning of multiple reptile pens as described herein, the reptile pen is partially submerged in water so that the reptile occupant has access to that element of its natural environment. The reptile can fully or partially submerge itself in the water or lay fully or partially out of the water on the floor area of the pen when located as described above partially in water.

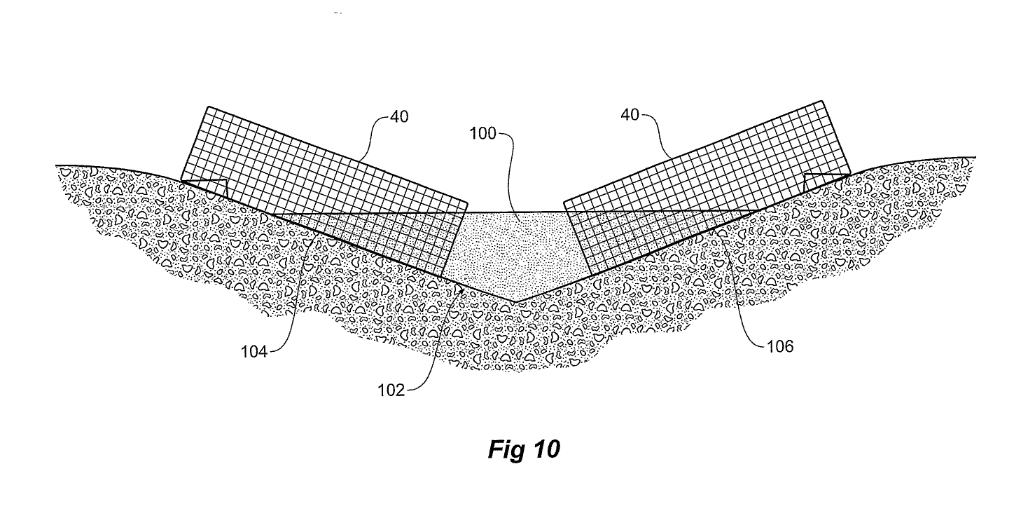

This positioning of the pen partially in water can be achieved in many ways with the embodiment depicted in FIGS. 10 and 11 showing the positioning of the nominal tail end of each reptile pen 40 in a body of water 100. The body of water is created by partially filling a trench 102 carved out of the ground but the water body shape could be created in a multitude of ways and could include a raised structure or a buried structure.

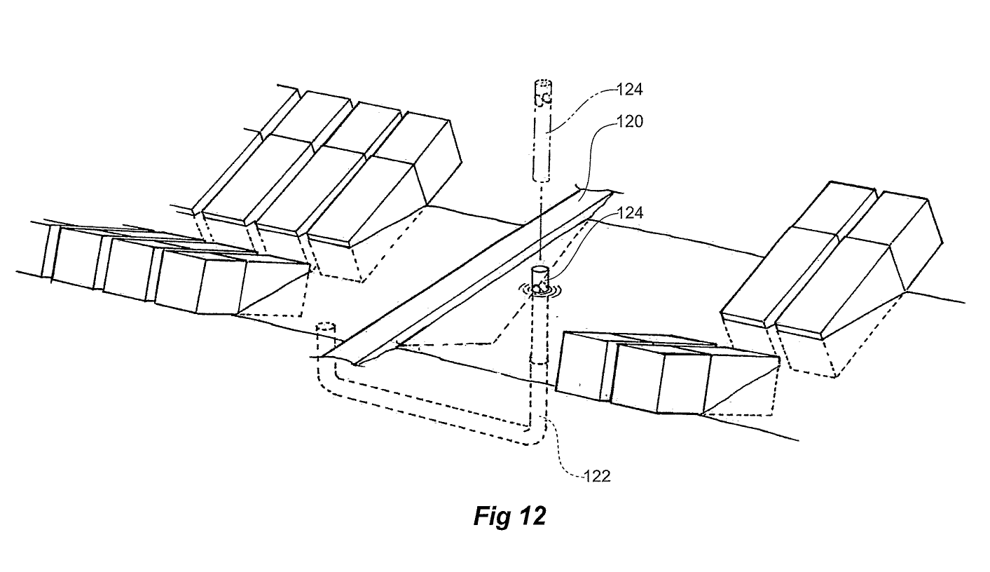

The trench, so called, has sloped sides 104 and 106 that provide a base for the floor 40b of each reptile pen and if constructed with appropriate dimensions, pens can be located on each side of the trench with tail ends adjacent or at least close to each other. The trench can have sloped side walls that conform to the substantially flat floor of the type of pens depicted in FIGS. 4 to 7 or the type of pen depicted in FIG. 8 as is illustrated respectively in FIGS. 10 and 11. It is sufficient to create a water body that allows the positioning of multiple pens therein but it becomes more economical to arrange the pens adjacent to one another tail end to tail end as depicted in FIGS. 10 and 11 as well as having adjacent side walls as depicted in FIG. 9 to allow for side-by-side positioning as depicted in FIG. 12.

The trench is preferably sized and/or the pens are located relative to the trench so that when water is drained from the trench, water is also completely drained from the reptile pens.

FIG. 12 depicts two trenches located adjacent one another having an end to end orientation where the bottom most point of one trench is higher that the desired top water level of the other trench. One variation of this is to form a single sloped trench and separate it along the length of the trench with one or more walls. The wall 120 in the depicted embodiment acts like a dam wall to provide water separation between trenches or portions of the same trench. An over-flow pipe 122 provides a means to maintain the level of water in the upper trench and the end of the over flow pipe terminates in the lower trench, to allow the flow of water from one trench to the other. The pipe 122 has a removable portion 124 that when removed, allows the respective trench to drain to a lower level. The removal action is shown with the aid of a phantom depiction of the portion 124 in a raised position.

Preferably the water in the trench is changed over at least twice every 3 days. This can be achieved by complete replacement or slow flow conditions.

FIGS. 10, 11 and 12 do not show a reservoir in which water treatment takes place or a sump from which water flowing through the trench are collected and pumped back to the reservoir. They can however be located at any convenient location so that water can either flow to the reservoir from the lowest set trench or flow from the reservoir to the highest set trench. A pump can be used to relocate the water so that a cycle s provided for filling or flow of water in the water body/s.

Not shown is the possibility of covering the whole or portions of the trench to better control the environment above the trench so that for example, the air and water temperature can be better controlled. This could allow the faster growth development of amphibious creatures in particular alligators. Control of the trench environment could also include insulation or heating of the foundation of the trench or the trench itself or indeed the water flowing through the trench. These and other arrangements may allow year long development of growth regardless of the season.

The reservoir is preferably the location for water aeration and treatment within the water ecosystem which becomes a part of the grow-out environment of the reptiles.

The pumping and re-use of water is advantageous in regions where water is a scarce resource or where waste water controls exist and the amount of waster water used is kept to a minimum.

It will be appreciated by those skilled in the art that the invention is not restricted in its use to the particular application described. Neither is the present invention restricted in its preferred embodiment with regard to the particular elements and/or features described or depicted herein. It will be appreciated that various modifications can be made without departing from the principles of the invention. Therefore, the invention should be understood to include all such modifications within its scope.

1. A reptile grow-out pen assembly for containing a reptile in particular, a crocodile includes:
an elongate container having at least one side having an opening for entry of food into the container and at least one closable and openable aperture associated with the container for entry and exit of the reptile, the container having at least a floor portion and side wall portion wherein in use of the reptile grow-out pen, at least a portion of the floor and at least a portion of the side wall are adapted to be submerged in water.

2. A reptile grow-out pen assembly according to claim 1 wherein at least one region of the floor of the grow-out pen is sloped with respect to another region of the floor, and where in use, at least a portion of the sloped floor region and at least a portion of the side are submerged in water.

3. A reptile grow-out pen assembly according to claim 1 wherein the assembly has a smooth internal floor and at least a smooth internal side.

4. A reptile grow-out pen assembly according to claim 3 wherein the internal side includes a high density polyethylene sheet.

5. A reptile grow-out pen assembly according to claim 1 wherein the reptile grow-out pen is constructed of connected structures that can be formed into a substantially flat structure.

6. A reptile grow-out pen assembly according to claim 1 wherein the reptile grow-out pen is adapted in an un-constructed state to be stackable.

7. A reptile grow-out pen assembly according to claim 1 further including at least two openings in the container for allowing insertion/removal of feed and the entry and removal of an incapacitating device.

8. A reptile grow-out pen assembly according to claim 2 wherein a portion of the floor is sectioned off from the remainder of the floor by a structure that is rises above the floor level to minimize, in use, the water affecting food placed on the sectioned off portion.

9. A reptile grow-out pen assembly according to claim 2 further including at least one internal reptile claw hold to allow a contained reptile to crawl along the floor surface.

10. A reptile grow-out pen assembly according to claim 2 further including a unique identifier of the occupant of the grow-out pen.

11. A reptile grow-out pen arrangement used for growing out of reptiles including:
at least one water body;
at least two reptile grow-out pen assemblies according to claim 2 wherein each assembly has a portion of the respective floor of the pen and at least a portion of the side of the respective pen submerged in the water body.

12. A reptile grow-out pen arrangement according to claim 10 wherein a pen is located adjacent another pen.

13. A reptile grow-out pen arrangement according to claim 10 wherein water flows through the at least one water body.

14. A reptile grow-out arrangement according to claim 10 wherein each water body has a water level that allows gravity to move water from at least one water body to another water body.

15. A reptile grow-out arrangement used for growing out of reptiles including:
a plurality of enclosures each having at least one water body and a sloped reptile basking region located within the reptile enclosure and wherein the enclosures are connected so as to allow the flow of water from one enclosure to another; wherein the proportions of the enclosure are predetermined to minimize infighting amongst the reptiles therein.

16. A method of growing out reptiles using a reptile grow-out arrangement of at least two enclosures each enclosure according to claim 15 of substantially the same proportions, the method of growing out the reptiles includes the step of:
moving successively smaller numbers of reptile occupants from one enclosure to another for predetermined periods of time as the reptiles increase in size.
